(19) United States
(12) Patent Application Publication
(10) Pub. No.: US 2017/0348834 A1
(43) Pub. Date: Dec. 7, 2017

(54) VEHICLE COVER SCREW TOOL AND METHOD OF USE

(71) Applicants: Daxon D. Miller, Lawson, MO (US); Mary C. Miller, Lawson, MO (US)

(72) Inventors: Daxon D. Miller, Lawson, MO (US); Mary C. Miller, Lawson, MO (US)

(21) Appl. No.: 15/612,861

(22) Filed: Jun. 2, 2017

Related U.S. Application Data
(60) Provisional application No. 62/345,192, filed on Jun. 3, 2016.

(51) Int. Cl. B25B 23/00; B25B 21/00; B25B 13/50; B62D 27/06; B25B 27/00

(52) U.S. Cl. CPC B25B 23/0035; B62D 27/065; B25B 27/0035; B25B 13/50; B25B 21/002; B25B 21/007

(57) ABSTRACT

A screw tool system for use with vehicle covers includes a vehicle screw adapter which interfaces with the receiver end of the screw and uses a standard cordless power screwdriver to drive the screw either into or out of the frame and vehicle top. A standard screwdriver handle could be used in place of the cordless power screwdriver. The cordless power screwdriver is preferred over a corded power screwdriver due to ease of use and lower power, which reduces the threat of stripping the screw.

### CROSS-REFERENCE TO RELATED APPLICATION

This application claims priority in U.S. Provisional Patent Application No. 62/345,192 Filed Jun. 3, 2016, which is incorporated herein by reference.

### BACKGROUND OF THE INVENTION

### 1. Field of the Invention

The present invention relates generally to a screw tool and method for use thereof, and more specifically to a screw tool for use with a vehicle roof component, namely a Jeep® hardtop screw.

### 2. Description of the Related Art

Many Jeep® Wrangler vehicles include hardtop vehicle covers which connect to the vehicle frame using a screw element. These optimally are “Kwick” screws which allow the user to unscrew and remove the hardtop for use of the vehicle in good weather conditions. However, these “Kwick” screws can be tedious to remove, and existing tools merely replace the manual hand removal of the screws with the manual hand removal of those same screws using a cylindrical tool which does not increase the efficiency of removing those screws by any significant margin. What is needed is a screw tool for use with power drills, cordless drills, or existing screwdriver handles which increases the efficiency of removing the cover screws.

Heretofore there has not been available a system or method for a vehicle cover screw tool with the advantages and features of the present invention.

### BRIEF SUMMARY OF THE INVENTION

The present invention generally provides a top cover screw tool for use with typically Jeep® Wrangler vehicles, manufactured by Fiat Chrysler Automobiles, headquartered at 25 St. James's St., London, UK, having hardtops. These hardtops are typically affixed to the vehicle using “Kwick” screws with a base screw terminating at a manually-turned top having a “T” shape, which may also include a circular rim and an indention at the center of the “T.” The present invention interfaces with the receiver end of the screw and uses a standard cordless power screwdriver to drive the screw either into or out of the frame and vehicle top. A standard screwdriver handle could be used in place of the cordless power screwdriver. The cordless power screwdriver is preferred over a corded power screwdriver due to ease of use and lower power, which reduces the threat of stripping the screw.

### BRIEF DESCRIPTION OF THE DRAWINGS

The drawings constitute a part of this specification and include exemplary embodiments of the present invention illustrating various objects and features thereof.

FIG. 1 is a side-elevational view of a preferred embodiment of the present invention shown in a typical environment including a power drill and vehicle screw.

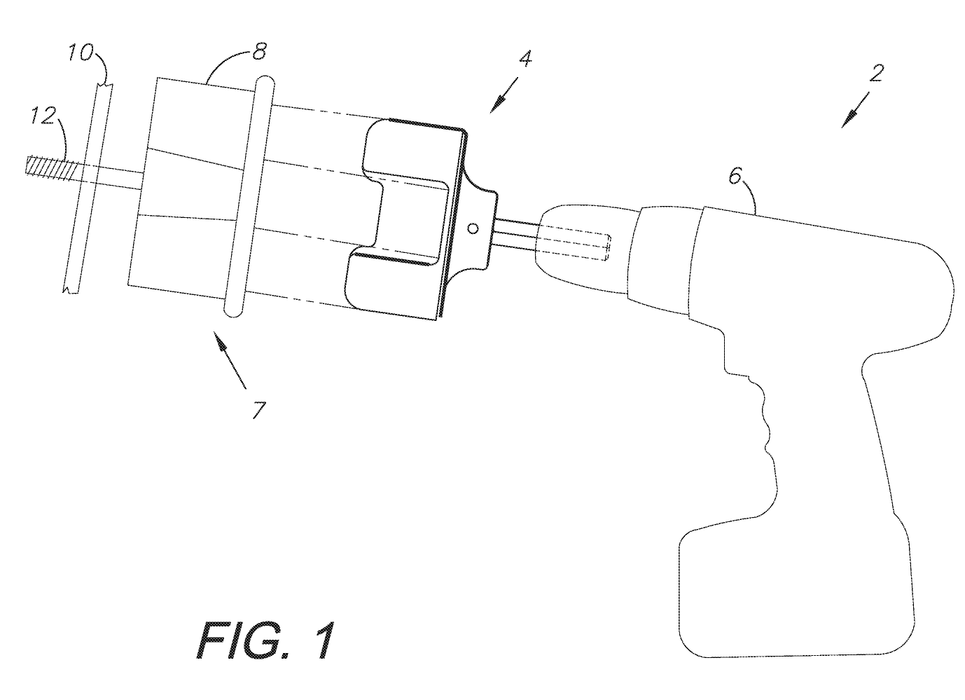

FIG. 2 is a three-dimensional isometric view of a vehicle tool element thereof.

FIG. 3 is a first side elevational view thereof.

FIG. 4 is a second side elevational view thereof.

FIG. 5 is a sectional view thereof taken about the line of FIG. 4.

FIG. 6 is a top plan view thereof.

FIG. 7 is a bottom plan view thereof.

FIG. 8 is a detailed bottom plan view thereof as taken about the circle of FIG. 7.

FIG. 9 is a top plan view of a prior art vehicle screw element thereof.

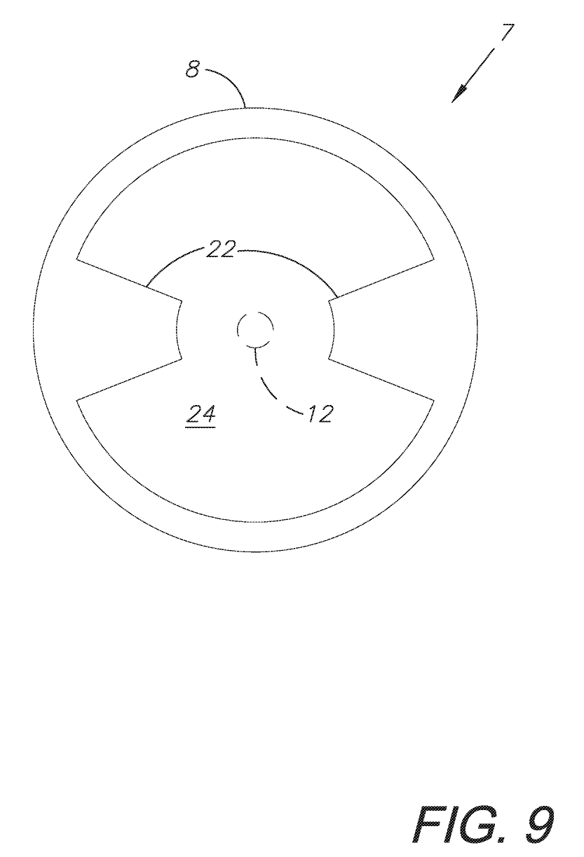

### DETAILED DESCRIPTION OF THE PREFERRED EMBODIMENTS

I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

II. Preferred Embodiment Vehicle Cover Screw Tool System 2

As shown in the figures, some vehicles (e.g. Jeep® Wranglers) include a hardtop cover 10 which is mounted to the roof of the vehicle's frame using cover-mounting screws 7. These screws 7 typically include a receiver 8 having a concave area with a T-shaped interface for manually gripping and loosening or tightening the screw to remove or affix the cover as required, and a screw tip 12 for passing through the cover 10 into the body of the vehicle (not shown), thereby securing the cover to the vehicle.

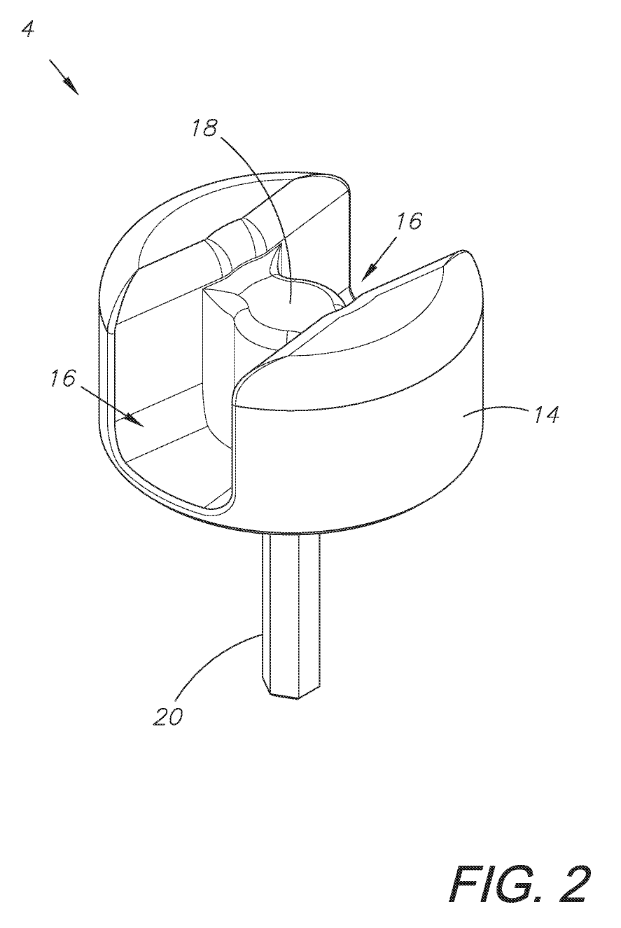

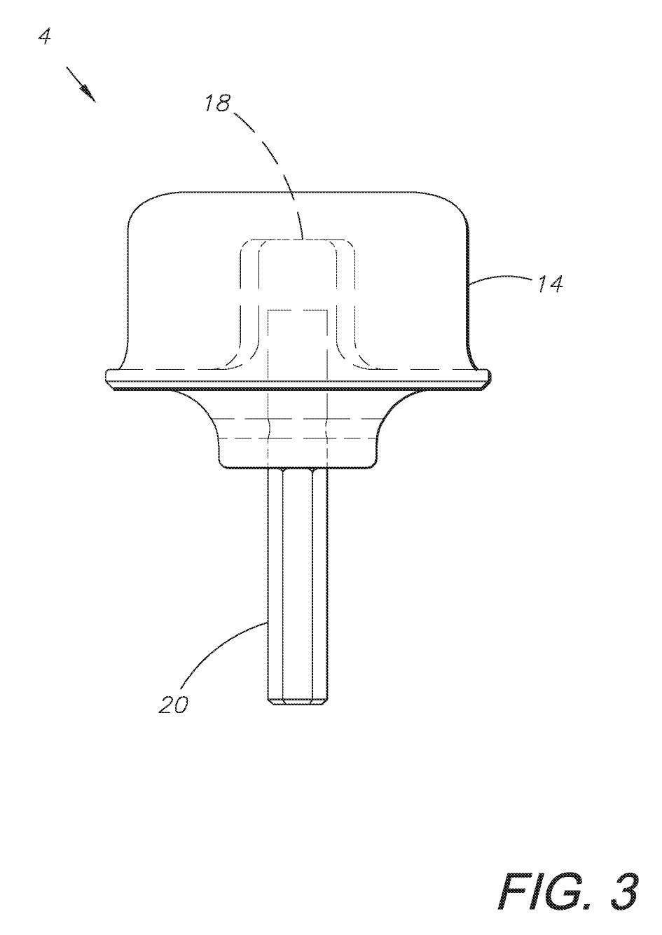

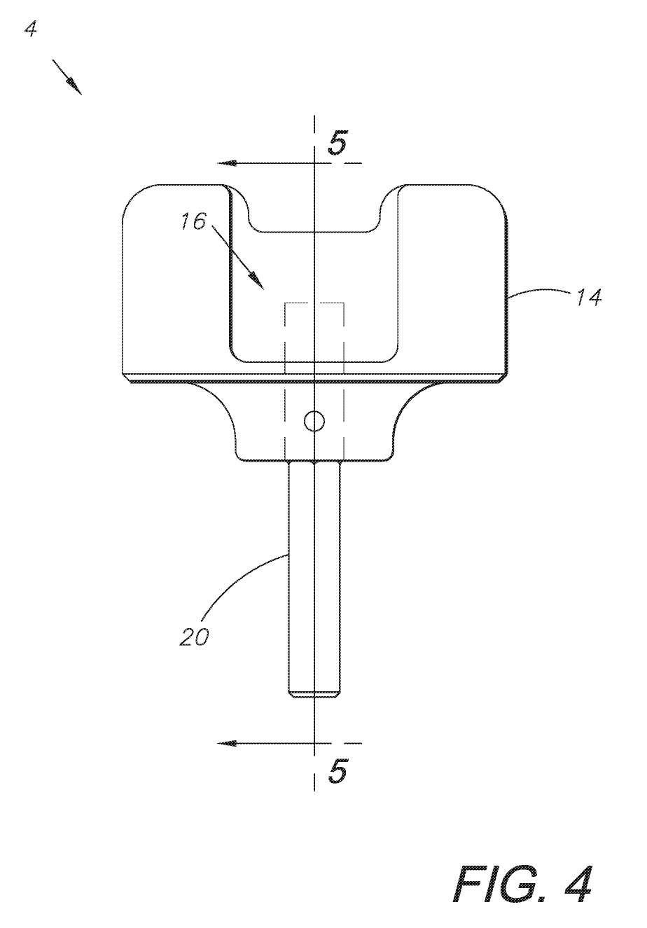

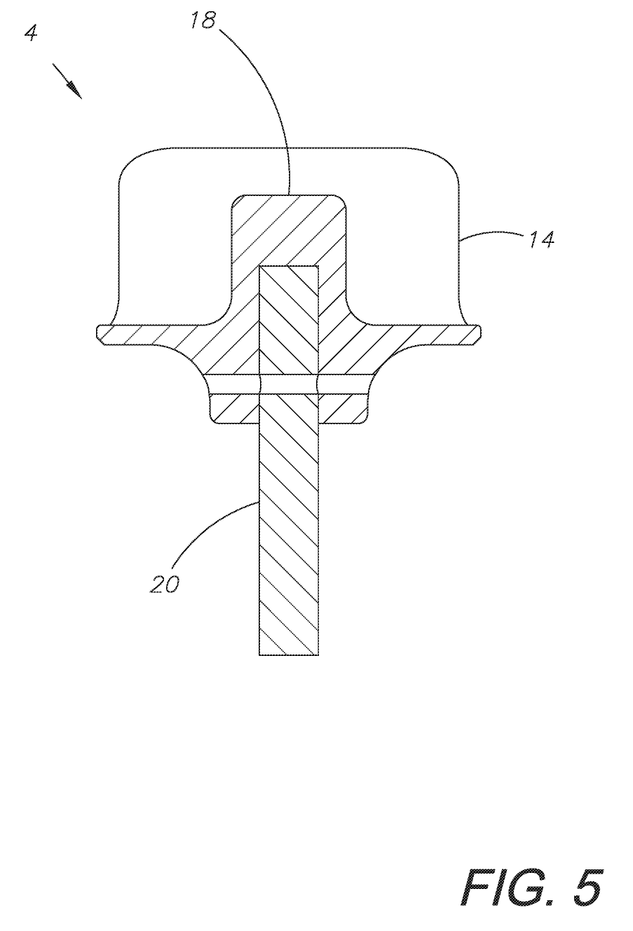

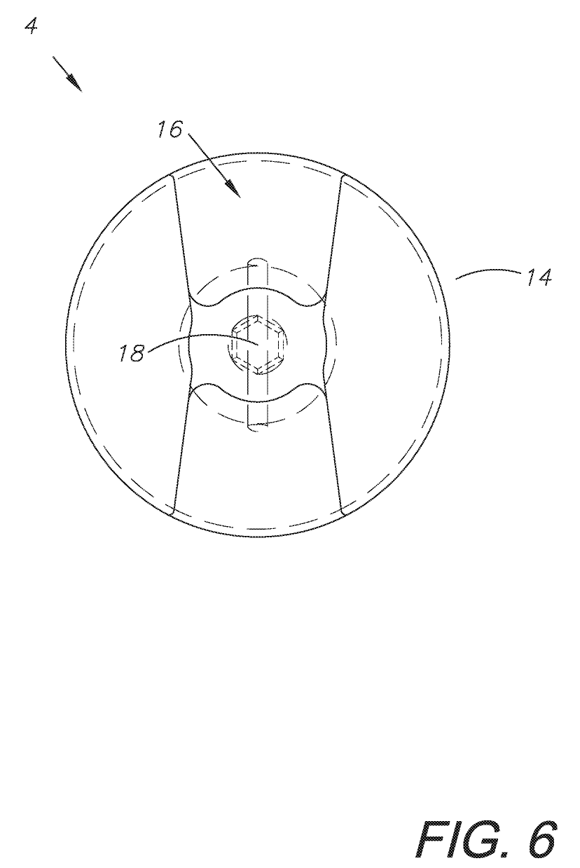

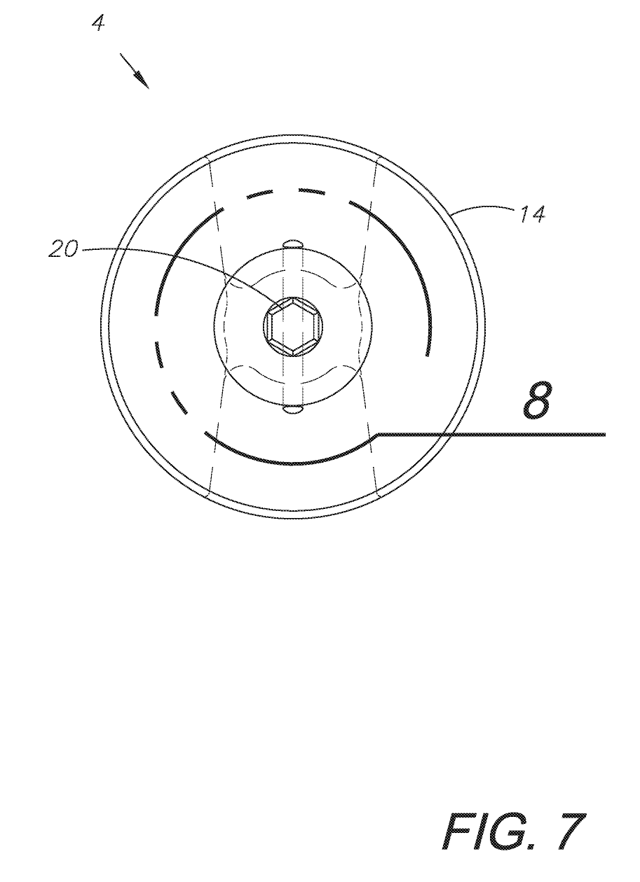

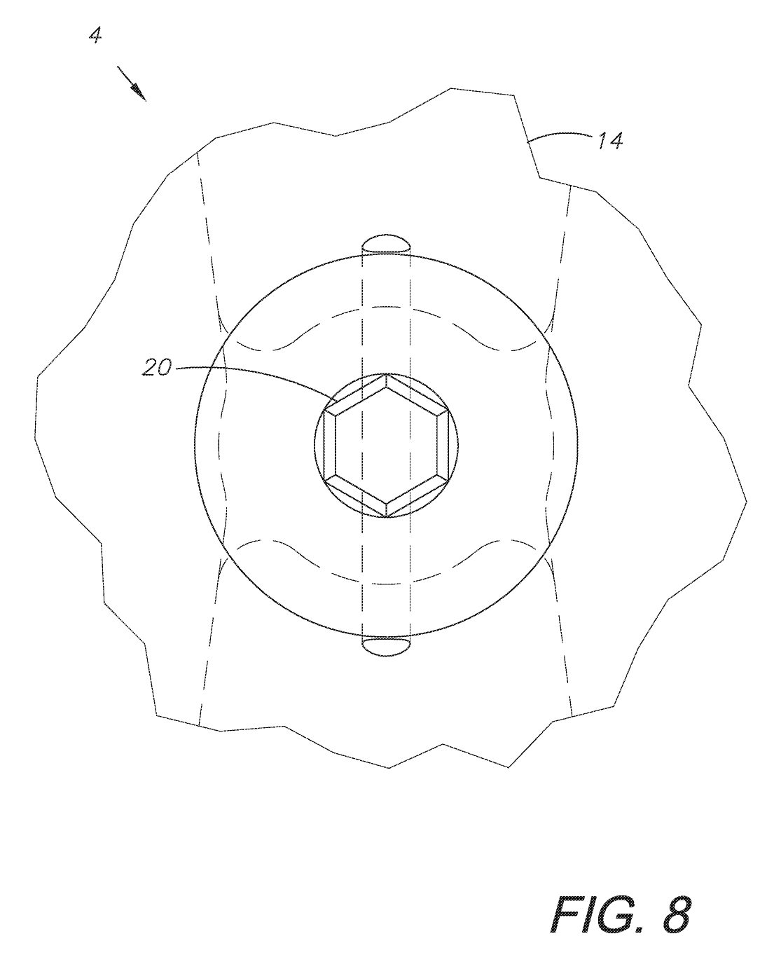

The present invention as shown in detail in FIGS. 2-8 includes a screw tool 4 which includes a head 14 designed to interface with the receiver 8 of the screw 7. The shape of the tool head corresponds to the shape of the receiver so that it fits securely within the receiver when operating. The rear face of the tool head includes a typical connector 20 (e.g. ¼″ interchangeable bit connector) for interfacing with the head of a cordless power drill/screwdriver 6, a universal screwdriver handle, or other suitable devices. A cordless power screwdriver is preferred over a power drill because of the potential damage the drill could do to the screw or the vehicle. Rather than tediously unscrewing the screw by hand, the screwdriver 6 cuts the time needed to remove or replace the screw 7 into a screw receiver within the vehicle frame and the top cover to a fraction of the original time.

The tool head 14 includes a raised central axis 18 and a pair of recessed receivers 16 for receiving the extended portions 22 of the screw 7. The raised central axis 18 and remainder of the tool head 14 are received within the interior space 24 of the screw receiver 8. With this arrangement, it is impossible for the screw 7 to slip within the tool head 14, ensuring complete installation or removal of the screw 7 through the cover 10 and into the vehicle frame.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A vehicle screw tool system comprising:
a vehicle screw having a receiver end and a screw end, the screw end configured for securing a vehicle cover to a vehicle frame;
a screw adapter having a head portion and a connector portion, said head portion configured to engage said vehicle screw receiver end, and said connector portion configured for engaging a driver tool; and
wherein said driver tool is configured to turn said screw adapter, thereby turning said vehicle screw into or out of a screw hole within said vehicle frame.

2. The vehicle screw tool of claim 1, further comprising:
said vehicle screw receiver including a recessed portion and a pair of protrusions;
said screw adapter head portion including a pair of recessed receivers for receiving said pair of protrusions of said vehicle screw receiver; and
said screw adapter head portion further including a raised central portion configured to be received within aid recessed portion of said vehicle screw receiver.

3. The vehicle screw tool system of claim 1, further comprising:
said screw adapter connector portion comprising a ¼″ interchangeable bit connector.

4. The vehicle screw tool system of claim 3, wherein said driver tool comprises a tool selected from the list comprising: a cordless power drill; a corded power drill; a cordless power screwdriver; and a universal screwdriver handle.

5. A method of connecting a vehicle cover to a vehicle frame, the method comprising the steps:
threading a vehicle screw end of a vehicle screw through a cover and into a screw receiver of a vehicle frame;
connecting a screw adapter head portion of a screw adapter with vehicle screw receiver end of said vehicle screw;
applying torque to a connector portion of said screw adapter using a driver tool; and
connecting said cover to said vehicle frame by screwing in said screw end of said vehicle screw into said screw receiver of the vehicle frame.

6. The method of claim 5, wherein:
said vehicle screw receiver including a recessed portion and a pair of protrusions;
said screw adapter head portion including a pair of recessed receivers for receiving said pair of protrusions of said vehicle screw receiver; and
said screw adapter head portion further including a raised central portion configured to be received within aid recessed portion of said vehicle screw receiver.

7. The method of claim 5, wherein:
said screw adapter connector portion comprising a ¼″ interchangeable bit connector.

8. The method of claim 7, wherein, wherein said driver tool comprises a tool selected from the list comprising: a cordless power drill; a corded power drill; a cordless power screwdriver; and a universal screwdriver handle.
